(19) United States
(12) Patent Application Publication
(10) Pub. No.: US 2002/0026342 A1
(43) Pub. Date: Feb. 28, 2002

(54) Multi-layer engine using generic controls for optimal routing scheme

(76) Inventors: Mark T. Lane, Franklin, TN (US); Runar Indseth, Austin, TX (US); G. Edward Powell, Austin, TX (US)

Correspondence Address: William N. Hulsey III, Hughes & Luce, L.L.P., Suite 2800, 1717 Main Street, Dallas, TX, 75201, US

(21) Appl. No.: 09/772,385

(22) Filed: Jan. 29, 2001

Related U.S. Application Data
(60) Provisional application No. 60/178,576, filed on Jan. 28, 2000.

(51) Int. Cl. G06F 17/60

(52) U.S. Cl. 705/8

(57) ABSTRACT

A scheduling engine for optimally scheduling the allocation of a set of service providers to a defined set of service points includes a service point mechanism for collecting and processing a plurality of service point data elements, and a service provider mechanism for collecting and processing a plurality of service provider data elements. A generic multi-layer scheduling mechanism generates allocation schedules for allocating the set of service providers to the set of service points irrespective of nonlinearity or dependence amongst said plurality of service point data elements and said plurality of service providers data elements. The generic multi-layer scheduling mechanism employs a heuristic algorithm for use of an objective function relating to said plurality of service point data elements and said plurality of provider data elements and said control parameters that describe what is important to the customer and generating therefrom an optimal allocation schedule.

This application claims priority of U.S. patent Application, Ser. No. 60/178,576, filed Jan. 28, 2000 entitled: “Multi-Layer Engine Using Generic Controls for Optimal Routing Scheme”, and is incorporated herein by reference in its entirety.

### BACKGROUND OF THE INVENTION

1. Technical Field of the Invention

The present invention relates to methods and systems for optimizing the use and allocation of limited resources over a multitude of possible routing patterns, and more particularly, to a multiple layer scheduling engine that employs a mathematical scoring function for which the complexity and nature of the scoring function may be modified to a wide variety of applications in an iterative fashion with meta-heuristic techniques that avoids reliance on linearity or independence of individual modeling parameters.

2. Description of the Related Art

In scenarios where time is limited, but a number of tasks must be completed or a number of deliveries must be made, clearly it is preferable to allocate resources optimally. Suppose there are five errands to run in a particular morning and two hours to complete them. These may include making a deposit at a bank, meeting an insurance agent, and picking up dry cleaning. Suppose further the bank does not open until 9 am, that the insurance agent is leaving the office at 10 am, and the dry cleaner is on the north end of town. How can these errands be best run in the shortest amount of time?

Time windows, visit locations, driving time and other limitations can all be related to a constrained scheduling problem. Usually, logistical problems are not extreme enough to warrant special software to find a least-cost solution, but this changes when trying to determine how to have 50 service providers conduct 300 cable installations in a day. Scheduling and logistic problems in these types of services can become difficult quickly.

There are a number of organizations that deploy a mobile work force, or that have a set of resources needing to be scheduled with several service appointments of jobs. There may be several classes of work or varied requisite skill sets for the different tasks. Much complexity is involved in the requirement that skills and constraints match allocation of company human and other resources to specific deployments.

There are a number of ways to invert the problem and solve it. One way is to use an approach called linear programming, such as with simplex method, in which there is a list of all the constraints on a set of linear equations. The constraints are not allowed to interact with each other. They must be independent variables. A problem with this approach is that in reality variables do interact and cannot properly be said to be truly independent.

There is also a need to be able to represent a nonlinear objection function that models a routing problem.

There is the need for a system that accommodates the interaction of variables representing the objective function.

Linear program solvers may work well for smaller problems. They, however, cannot solve problems involving many thousands of customers, because huge matrices result that have to be inverted. Large matrix inversion, however, requires significant amounts of CPU time and memory.

The interaction between constraints can create completely conflicting objectives. Suppose, for example, that one constraint is driving time, while the other is being promptly on time to begin a service call. To optimize driving time, one service person could do the work and drive all over the specified region and that is the optimal driving time. The problem this creates is that the service person must work overtime. Some appointments will be missed. On the other hand, if there is the constraint of making sure that the service person promptly meets appointments, then one approach is to have only one service person wait in front of the house for the time window, without worrying about driving time. This would make sure you meet the time window. Most companies, however, do not want to hire one service person for each service call, they want to maximize their resources and do not have a complete resource set with which to work.

The conflicting objectives of minimum driving time and time in work coupled with reducing inefficiency with waiting time. This results in one rule of reaching a service location before a service window starts.

Another limitation of prior art scheduling engines relates to their inability to effectively handle personal preferences. Sometimes providers may, for example, refuse to serve houses where a smoker resides or near cats to which they may be allergic. There are a number of possible personal preferences on the use and deployment of resources. These preferences exist on the part of service providers and customers in many different forms. In particular, a customer may particularly like or dislike a given service provider. Accordingly, to include consideration of personal preferences, parameters would significantly improve the quality of a scheduling method and system. These may be viewed as intangible costs, because violating such preferences over time may result in service persons quitting their jobs.

There is the need, therefore, to estimate the intangible costs to violating certain preferences and constraints.

In the situation where different providers require different objective functions within the algorithms, there is the need for accommodating a single set of algorithms and heuristics that can be used for any kind of customer. In other words, for example, utility companies, HMOs, lawn care companies, pest control services, and other mobile work force require different objective functions that relate to their different functions. With these different functions, there is the need for ways of telling the scheduling engine what is the problem or scenario. The scheduling engine should deal not only with where the customers are and what their needs are, but also what the capabilities and preferences of the providers are.

There is a further need, therefore, for a scheduling engine that permits a wide array of different providers to use an array of objective function algorithms to achieve optimal allocation schedules between service providers and service points.

### BRIEF SUMMARY OF THE INVENTION

The present invention addresses and overcomes the numerous limitations identified above to provide a scheduling engine that optimally schedules the allocation of service providers over a defined set of service points without the need for complex matrix inversions or the dependency on linearity and independence amongst the different parameters and constraints associated with the different service providers and service points.

According to one aspect of the invention, there is provided a scheduling engine for optimally scheduling the allocation of service providers over a defined set of service points. The invention includes a service point mechanism for collecting and processing a plurality of service point data elements, and a service provider mechanism for collecting and processing a plurality of service provider data elements. The service point data elements and service provider data elements may be nonlinear function elements and may be dependent data elements. The invention further includes a generic multi-layer scheduling mechanism for generating allocation schedules for allocating the set of service providers the set of service points. The generic scheduling mechanism employs a greedy genetic algorithm for creating an objective function relating to the plurality of service point data elements and the plurality of service provider data elements and generating an optimal allocation schedule therefrom.

The present invention, therefore, provides a scheduling engine that uses collections of service points and service providers along with their constraints, costs, and locations and a set of scheduling parameters. The scheduling engine finds a least-cost solution to scheduling service providers to the service points.

The traveling salesman problem (TSP) must have a single salesman (or provider) visit each city on a route once and return home while driving the least possible distance. The present method and system provide a very good approximation to the solution for the TSP. In addition, the scheduling engine of the present invention provides a flexible system for including additional constraints to the problem and determining the importance these constraints have when determining the solution with the lowest cost.

The present invention is generic in that it has no knowledge of particular scheduling domains. Different features provided by the present invention in various applications include the ability to (1) create routes that involve bin-packing of trucks; (2) minimize driving time while adhering to time window constraints; (3) model a system with an unlimited number of skills, preferences, or other requirements; (4) preclude two providers from arriving at a service point at the same time; (5) force a supervisor to attend to a service point at the same time as another service provider; and (6) vary the importance of any scheduling factor to accurately model a particular scheduling problem The present invention inserts the objective function into the algorithms to permit the objective function to change without affecting the associated algorithms. The scheduling engine operation is based on the principle that as long as any two solutions exist, it is possible to tell which is better. The scheduling engine constructs an objective function and generates a great number of solutions to obtain a best solution. This is all based on the fundamental premise of comparing and matching different solutions along the way.

The present invention uses a number of heuristics within a genetic algorithm to mimic biology in a random population of solutions. The method entails performing a number operations on those solutions to proceed in successive generations to achieve an optimal population including the best solution member. The genetic algorithms used in the present invention use meta-heuristics, which involve combinations of heuristics such as a tabu-search method. These types of heuristics allow making less than optimal moves in the process of getting a better solution. For example, climbing a mountain a tabu-search method may go down a hill a little to reach an edge that will permit taking more upward steps later. The tabu part of this approach avoids making a move, which has already been added to a tabu list.

The present invention permits the use of different heuristic approaches according to the particular problem within the genetic algorithm. Further examples of genetic algorithms and related work may be found at the Internet website of the North Carolina State University College of Engineering, Department of Industrial Engineering's Meta-Heuristic Research and Applications Group, (http://www.ie.ncsu.edu/mirage).

The key aspect of the present invention is the ability to generalize the objective functions, using these multi-layers and the parameter controls that may be inserted in any meta-heuristic to find the best solution. The best solution is when the method and system have reduced the objective function as far as possible.

While any meta-heuristic algorithm can be used in conjunction with the present invention, the present invention demonstrates the use of a “Greedy Heuristic” within a genetic algorithm. The Greedy Heuristic is able to construct a solution from scratch given any objective function. The Greedy Heuristic takes an objective function and determines the next step based on the shortest cost or shortest objective increment from the prior position. By taking the shortest cost approach, not withstanding some inaccuracies that may develop, the Greedy Heuristic, over time within a genetic algorithm, allows the evaluation of successive populations to guide the algorithm toward the optimum solution. The use of the evaluation of the objective function for the solution produced by the Greedy Heuristic may be considered as a “generalized scoring model”. Using this generalized scoring model avoids the need for very complicated matrices of linear programming, as well as individual constraints mapped out in separating equations. By showing which of two solutions is better, as determined by the generalized scoring model, the scheduling engine permits starting off with randomized data and focusing on operations where the Greedy Heuristic drives the generations to an optimal solution. The present invention uses this procedure in every operation of the genetic algorithm.

The present invention employs multiple layers in a complex scoring approach so that the generic controls are all parameterized. A non-linear penalty function having different costs that relate to the different components of what can be important to a business. The Greedy Heuristic allows easy insertion of a parameterized scoring model to produce a generalized scoring model. The primary input to the Greedy Heuristic is the insertion order of service points. The goal of the scheduling solution is to produce the best insertion order input to the Greedy Heuristic algorithm. The genetic algorithm can determine the goodness of fit by the evaluation of the objective function on the solution produced by each application of the Greedy Heuristic algorithm. The genetic algorithm starts with a random population of different insertion orders for the Greedy Heuristic, and the algorithm proceeds to operate on these insertion orders as it searches for more fit orders. Note that the objective function is evaluated at each step so that the algorithm can monitor the progress of the population of insertion orders. Then the genetic algorithm allows moving the population to converge to a fitter population.

The foregoing has outlined some of the more pertinent objects and features of the present invention. These objects should be construed to be merely illustrative of some of the more prominent features and applications of the invention. The present invention demonstrates the application of the present invention utilizing a Greedy Heuristic algorithm to produce a generalized scoring model and application of the objective function as a factor in a general genetic algorithm. Many other meta-heuristics can be used with the present invention in place of the one described here. The invention hinges on the ability to utilize a general objective function, which can have interacting constraints and non-linear components, as a driver for an iterative technique for producing the optimal solution that yields the best cost. The present invention, therefore, provides the ability to use the Greedy Heuristic or genetic algorithm in a scheduling problem, however other algorithms of similar purpose may also be used with the present invention. Many other beneficial results can be attained by applying the disclosed invention in a different manner or modifying the invention as will be described. Accordingly, other objects and a fuller understanding of the invention may be had by referring to the following Detailed Description of the Preferred Embodiment.

### BRIEF DESCRIPTION OF THE DRAWINGS

For a more complete understanding of the present invention and the advantages thereof, reference should be made to the following Detailed Description taken in connection with the accompanying drawings in which:

FIG. 1 illustrates the configuration of an optimized schedule formed according to the teachings of the present embodiment; and

FIG. 2 depicts a skill cost example for demonstrating certain features of the present embodiment.

### DETAILED DESCRIPTION OF THE PREFERRED EMBODIMENT

The present embodiment provides a scheduler that uses collections of service points and service providers along with their constraints, costs, and locations and a set of scheduling parameters. The general method and system is to find a least-cost solution to the problem of scheduling the providers to the service points. For example, The Traveling Salesperson Problem (TSP) describes the problem of a single salesman visiting each city on a route once and returning home while driving the least possible distance. At its core, the present embodiment allows the TSP as a specific case of the generalized method and technique. In addition, the present embodiment provides a flexible system for including additional constraints (other than driving distance) to the problem and determining the importance that these constraints have when determining the solution with the lowest cost.

The present embodiment is generic in that it has no knowledge of particular scheduling domains. The following discussion provides a brief overview of the classes of the present embodiment, then moves to a case study to show how to integrate the present embodiment into an application.

One of the keys to using the present embodiment in an application is to gain a thorough knowledge of the domain for which scheduling is sought. In our application of this methodology, there are over 40 objects definitions that may be grouped below according to functions of (1) scheduling engine; (2) problem domain contractions; (3) system program settings; and (4) schedule output.

A complete understanding of these classes is not required to use the present embodiment, but to accurately model a particular situation, an understanding of the most appropriate classes is preferred. The breadth of methods available is broad, as will be described more fully below.

Objects used in the construction of the scheduling problem may include the following:

Service Point—representing a service point: e.g., a customer or patient.

Service Points—representing a collection of Service Point objects.

Map Coordinates—representing the latitude and longitude where a provider or a service point may be located.

Continuity Of Care Provider Weight—representing a weight for a specified provider ID (to be used in a Service Point object to denote how important a specific provider is to that service point.)

Continuity Of Care Provider Weights—representing a collection of Continuity Of Care Provider Weight objects.

Time Penalty Function—holds parameters that specify the coefficient and exponent of a time penalty function. For use with overtime and over availability for Provider objects and with late time for Service Point objects.

Provider—represents a service provider; e.g. a nurse.

Providers—a collection of Provider objects.

Break—represents break parameters for a service provider; e.g., break length and pay and time window boundaries.

Breaks—a collection of Break objects.

Binary Requirement Category—a requirement category, a way of grouping requirements based on their importance (in terms of the penalties for missing the requirement), operator (AND/OR/NOR), etc.

Binary Requirement Categories—a collection of Binary Requirement Category objects.

Binary Requirement—a requirement object describing one possible requirement in terms of its name and category.

Binary Requirements—a collection of Binary Requirement objects.

Binary RequirementSet—a set of requirements

Universe Binary Requirement Set—the set of all possible requirements in a given scheduling domain. It also contains a collection of all the possible categories.

Compartment Type—represents type information for compartments in a service provider's truck. For use only with bin-packing problems.

Compartment Types—a collection of Compartment Type objects.

Compartment—represents parameters associated with a specific truck compartment for use by a service provider in bin-packing problems.

Compartments—a collection of Compartment objects.

Compartment Need—represents the level of need for a specified type of compartment. This is used in bin-packing problems to specify the quantity of packed material that a provider delivers to a service point.

Compartment Needs—a collection of Compartment Need objects.

Objects used to input scheduling options for running scheduling engine may include the following:

Scheduling Engine Options—a collection of option objects that determine how the scheduler should operate. Some of the option objects pertain to and are named after particular algorithms or heuristics. It is through these objects that the algorithm's behavior is enabled, disabled, or otherwise modified. There is also a scheduling options object for the scoring model. Each option is retrieved from the options collection using a key word as a look-up into the table of options.

Scoring Model—a scheduling option object type which lets the client change the scoring parameters, including weights of penalties for missing time windows, etc.

General Options—Scheduling options not tied to a specific algorithm or heuristic.

Basic Inserter Options—This enables or disables the basic inserter algorithm and houses parameters for governing its use in the Test Insertion heuristic.

Basic Starter Options—Controls the starter process and the setup of the main computation phase.

Full Insertion Heuristic Options—Controls the operation of the full insertion heuristic.

Insertion Improvement Options—Controls the insertion improvement heuristic. This heuristic can be run in any of the computation phases of the engine—as a starter it will improve the output from the other starters, during the main phase it will improve intermediate results, and as a finisher it will improve the final result during the “.End” phase. Because it is CPU intensive, it should be selectively enabled and disabled through this options object before each of the engine phase operation calls.

Radial Sweep Options—This option package is no longer used in the present embodiment.

Maximum Removal Options—This option package is used to control the maximum benefit removal algorithms in the present embodiment, including holding a place for priority-driven removals.

Local Hill Climb Options—This option package is used to enable or disable the local hill climb algorithm that is used as a finisher for the insertion improvement heuristic algorithm.

Genetic Algorithm Options—Options to enable or disable the GA, tell it how many generations to run, etc.

Objects used to describe the output of the solutions produced by the scheduling engine may include the following:

Schedule Item—a visit in a schedule, with information about what Service Point to visit, when to visit, etc.

Schedule Items—a collection of Schedule Item objects.

Schedule—a schedule for a provider, includes an list of Service Points ordered by time.

Schedules—a collection of Schedule objects.

Solution—a solution to a scheduling problem described in terms of Service Points and Providers.

The classes listed above allow a user to describe a scheduling problem in terms of the providers, the service points these providers must service, where the providers and service points are located, and the requirements the service requests pose.

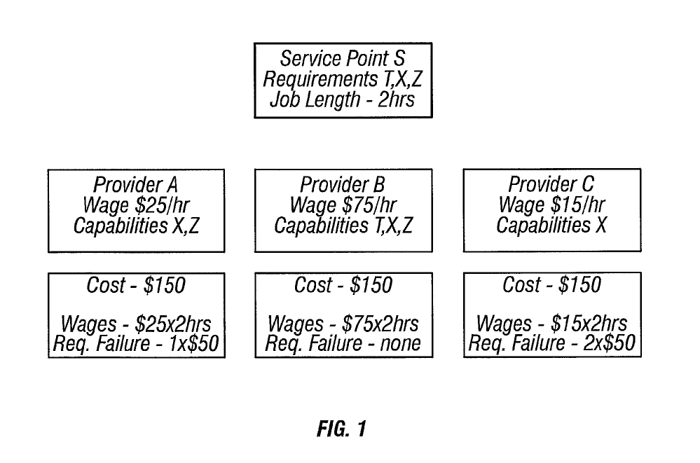

Referring to FIG. 1, one way to see the present embodiment in operation may be to consider its use with a software system designed to optimize the problem 10 of delivering health care service 12 to homebound patients. The functionality of such a software system will assist in framing a scheduling problem. The purpose of the following example is to establish by example a familiar domain in which to describe some of the scheduling engine's functionality.

In the home health domain, patient visits are the service points 14 and health care givers are the providers 12. Providers 12 are assigned a patient schedule 16 and then drive to the patient's homes to deliver care. The providers will either start their day at their own homes or at the agency for which they work.

Individual visits may have many requirements. The most important requirement for a visit is that the provider be licensed properly 18 to perform the visit. Also of high importance is that the providers have the adequate skills to perform the services needed for a visit. Other important factors include continuity of care (that the same nurse or small group of nurses should see the same patient), driving time, patient and provider preferences, provider availability, types of visits the providers prefer, medically necessary time windows, and other cost factors. The importance of these factors will vary depending on the agency scheduling cost model.

To better understand the scheduling problem 10 setup, a brief introduction to the method and system of the present embodiment scheduling is useful. The present embodiment attempts to determine a least-cost solution by inserting each provider 12 into each visit and determining the cost of that solution. In other words, the scheduling engine 24 derives multiple schedules and returns the schedule with the lowest cost. The cost of a schedule is determined by adding the costs of performing the services at each service point, given the assignments, times, and ordering of the produced schedule.

For example, one cost factor may be the distance a provider must drive to reach a service point. If this were the only factor, the result would be a solution to the Traveling Salesman Problem. Another tangible cost associated with a particular provider making a visit, however, may be the wage paid to the provider. All other factors being equal, it is less expensive to have a $6/hour employee do the work than a $10/hour employee. While these factors are quite obvious, the less obvious intangible factors are the key to the scheduling strength and flexibility.

As was previously mentioned, visit time windows are likely to be very important in the care service industry (e.g., The visit must occur between 9 am and 11 am). The present embodiment penalizes every provider that cannot make a visit within the specified time window. Through this process, the cost of the solution with providers making visits outside of time windows will be higher and less likely to be the preferred solution.

Notice that hitting time windows accurately and reducing the driving distance are opposing constraints. Which constraint is more important derives from the size of the penalty given to missing a time window. If this penalty is low, drive time is more important, and vice versa. All of the weights used in the present embodiment are relative to each other.

The process of using the present embodiment to create a schedule is similar from domain to domain. The key to differentiating between the domains is the set of requirements and the general cost model. In general, the steps used to create a schedule using the scheduling engine of the present embodiment are first to define the types of requirements that may be encountered in the domain and the weights the requirements should use to influence the solution, building a collection of available providers, and their capabilities to fulfill various requirements may be next.

Building a collection of service points that must be serviced, along with the work occurs next, and these collections are then sent to the scheduling engine. The options the engine provides for the specified domain are then set. The engine is then instructed to generate an optimized solution to the scheduling problem. The result is then processed by iterating through the schedules in the solution the engine returns. If necessary, resetting the scheduling parameters and options and rescheduling may then proceed.

The scheduling domain problem has constraints, rules, and parameters that need to be identified. For example, a patient may have a preference for a particular nurse, or a plumber may need a particular skill or tool to complete a visit. The present embodiment uses a system of binary requirements to create a flexible, powerful modeling tool for many problem domains.

Requirements fall into two groups: hard requirements and soft requirements. In the care service industry domain, for example, licensure will most likely be considered a hard requirement, a requirement that cannot be violated under any circumstance. Other requirements are considered soft requirements. It is up to the person responsible for constructing the cost model to determine how much of a factor each requirement will be in the final solution. Ultimately, a service point will have a set of requirements and the provider will have a set of capabilities. For each requirement that a provider is not capable of meeting, a penalty will be assessed to the solution that contains a schedule with that provider making the visit .

Defining the requirements involves creating a universe requirement set, and categories of requirements. The categories include the types of requirements that the applicable domain will use, as well as the effect the category should impose on the solution if the requirement fails.

The weights for the various soft categories will likely be set through an administrative user interface or a database driven properties file. This will allow configuring the weights for various scheduling profiles. The weight for a hard skill should be set very high (orders of magnitude higher than any other weight) so no preferred solution could ever violate this constraint.

The next step is to inform the universe about these categories. This entails defining the actual requirement names, linking them to their category, and adding them to the universe requirement set.

The database can be used to create all the possible values of the requirements in each category. Note that the constructor builds the requirements universe from the license table in the database. For efficiency, it may be desirable to use the primary key ID of the licenses from that table. This permits constructing the requirement sets for the visits and the providers without looking up the name of the licenses from the license table through the foreign keys. The categories are filled with values in the same order the categories were initially added to the universe of requirements. This allows proper verification of the requirement sets.

Certain scoring penalties exist for requirement failures. Every binary requirement category has a scoring operator and weight. These properties determine the penalty for any provider who does not meet the requirement.

A patient visit may require a provider to have one of a small set of licenses to perform the visit (it is also possible that the provider may have multiple licenses). A solution associates with a provider to make a visit where none of their licenses is in the set of licenses required by the visit should be penalized. If one of the licenses matches, that is sufficient. The “OR” scoring operator is appropriate in this circumstance. When using the “OR” operator, the penalty is assessed only if none of the provider licenses matches the license needed to make the visit. If none of the licenses match, the penalty set by the category weight is assessed to that provider, making it less likely that the provider will ultimately be assigned the visit. Conversely, a provider should be penalized for every skill that she does not have that is needed for a visit.

Having just one of the skills (as in the case of the license) is not sufficient in this circumstance. The “AND” scoring penalty assesses a penalty for each missing skill. The category weight assigned to a soft requirement failure must be balanced against other scheduling considerations. Scheduling parameters are discussed later in the document.

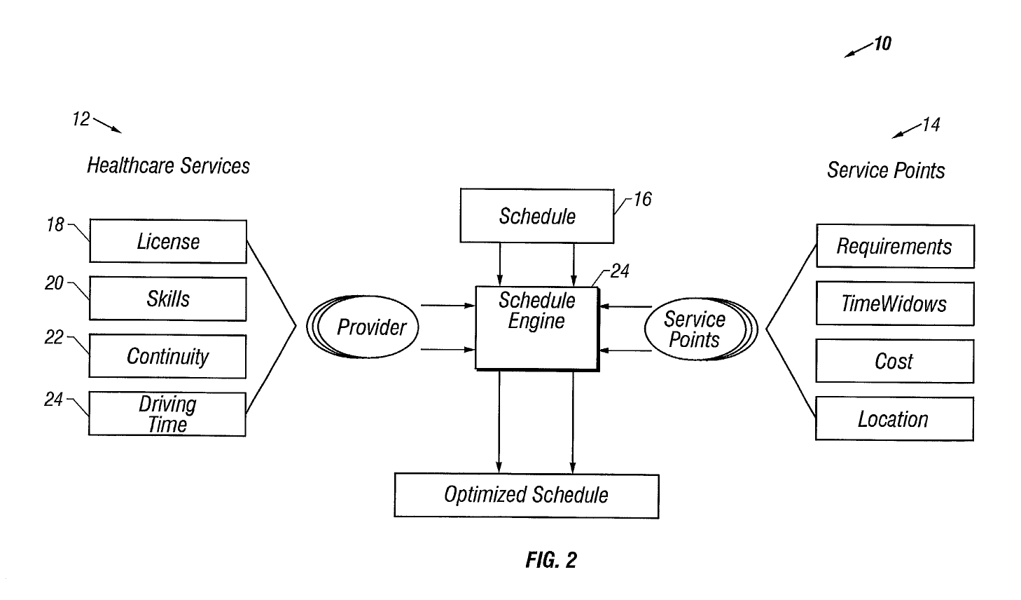

FIG. 2 shows a further example to illustrate the penalty structure for “SKILL” and how it influences the solution. Assume all factors other than skills and wage are equal. Note that the preferred embodiment does not use dollar amounts when finding least-cost solutions. This convention is being used to simplify the comparison process.

The least cost provider in this scenario is Provider A. Although Provider A had one skill failure, overall there was a lower cost than either of the other providers. Provider B had no skill failures, but due to a high wage was still the most expensive. If skills are more important than wage considerations in your cost model, setting the skill penalty higher may be necessary. Had the skill failure penalty been $125 instead of $50, provider B would have been the best choice at $150, when compared to Provider A at $175 and Provider C at $280.

A service point is a customer with a location, a need for services, and a unique identification. Minimally, the service point has a location and a time window in which the services are to be provided. In addition, the services may require special provider skills. Other typical service point information includes (1) licensure and other requirements; (2) job length; and (3) job date.

In general, the necessary information will be from the database and construct service point objects for each visit, adding them to the service points collection along the way. In this short example, the values have been hard coded. If another location needs to be visited immediately following this service point, e.g., for a blood-drop, this may be specified by setting the post visit property to another service point object.

Creating a provider collection object happens by reading the necessary information about the provider from the database, creating a provider object for each one of them, and adding each of these objects to the provider collection.

If a provider has a split shift (i.e., two sets of time windows, e.g., 7 am-11 am and 4 pm-11 pm), the provider may be passed into the present embodiment as two providers with distinct identifier, e.g., 101 and 101B. After the schedule comes back, the solution will be parsed and the visits for 101 and 101B will be placed in the schedule for provider 101.

The keys to using the present embodiment successfully are knowing the scheduling domain and knowing how to use the scoring parameters to model that domain. The present embodiment has default values for all the scheduling parameters. In most cases, the default parameters are the best place to start. The following discussion includes some simple settings and how to change the settings in the present embodiment.

Before the scheduling engine of the present invention can work, the data for the service points and providers must be complete. Minimally, the service points must have (1) date for service; (2) time window for service; and (3) a location (latitude and longitude). The providers must have (1) time when they are available to work; and (2) a location (latitude and longitude). The input data should also include all service point requirements, provider capabilities, costs associated with the visits, and other cost model information. Typically this information will also include the location of a central office and the scheduling parameters.

The time window that the scheduling engine will schedule depends on the range of dates and times included in the service point collection. Usually, the collection of service points will reside in a database and only date or time specific service points, as determined by the user, will be included in the collection sent to the present embodiment. Similarly, only the providers who are able to work during that time period will be included in the provider collection.

An engine object needs to have been declared and instantiated. Typically, this will be a global object The engine needs to know which providers are available and which service points need servicing.

The engine has three distinct phases in which it does the optimization work. The “Begin” phase runs the starter heuristics enabled through the options. This phase can only be run once. The second phase is the main work phase. In this phase the engine runs the most complicated, time-consuming algorithms. The “Work” phase can be repeated multiple times with different options, (e.g. enabling different algorithms) and it continues where it left off from the previous call. The final phase runs “End” (finisher) algorithms as enabled in the present embodiment options. This phase can only be run once.

The calls to the present embodiment are by default asynchronous. The engine queues up work requests to a secondary worker thread. The methods return immediately after successfully adding the request to the queue. The worker thread then services the requests sequentially. However, it is permissible to change the options in between these calls without waiting for the operation to finish because the engine takes a snapshot of the options that are given to the worker thread along with each scheduling request. These calls can also be made synchronously (blocking—i.e., they are run in the same thread as the set-up code).

To determine when the scheduling engine has completed its operation, the client should examine the engine's “Done” property. The engine returns True when the processing for the “End” call has finished, and False otherwise. The user interface should poll the engine with a timer object or some other mechanism to see if the engine has completed its work. When the engine is done, the timer should be disabled, and the client should proceed to import the results by iterating through the schedules and schedule items in the solution, as described in the next section.

Inspecting the solution occurs by examining the solution property of the engine object. The solution object consists of various solution statistics (errors, total time, distance, etc.) as well as a collection of provider schedules. To inspect the solution, the present invention iterates through the schedules.

The provider object of the schedule is a reference to the same provider object that was initially passed to the scheduling engine. Consequently, all the provider properties (location, capabilities, etc.) are available through the object interfaces.

A schedule item contains visit information, such as when that visit should take place, and some statistics about errors and requirements failures, etc. The schedule item contains a reference to the service point to which it represents a visit. This is the same object as one of the service points that were originally added to the service points collection passed to the engine.

To set the scoring model properly can be confusing to the first-time user of the present embodiment, because objectives often conflict with one another. For example, it may be counter-productive to optimize driving time when time window constraints are more important. Also, setting certain parameters in the scoring model, such as whether to score by time or by cost can cause other settings in the model to be ignored while enhancing the model in other areas. It is important for the user to understand how the model will affect their scheduling problem.

General scoring considerations include the weights for skill failures, which are all given in objects that are constructed in the universe binary requirement set. If changes to these weights are desired, then the entire universe binary requirement set object will be rebuilt and set in each of the service point and provider objects in the engine. Then, the engine's reinitialize method will be called. Typically, these weights are set once, but there may be the need to reinitialize the system if it is desired to change the weights assigned to a binary requirement category after a partial solution has been calculated. It is important to realize that skill weights are intangible costs to a score of a schedule and solution. Since all costs are accumulated in parallel and decisions are based on the accumulated score, it is important to keep these failure weights in mind when constructing a good scoring model.

If the scheduling engine uses a GIS system, then a GIS engine will calculate all distances and drive times in matrix form. If this engine fails to return a driving time and distance, it returns a flag indicating that the present embodiment must calculate the distance using the distance estimate method. In this case, the line of sight speed property of the scoring model object is used to determine the driving time between any two points. Moreover, if the additional travel seconds property of the general options property is set, the present embodiment will add a predetermined number of seconds to each driving time to make sure that even close distances have a certain amount of time between them.

There are two fundamental approaches to scoring schedules: scoring by time and scoring by cost. When scoring by cost, the present embodiment attempts to model how much it costs to perform a solution of schedules. Pay scales are applied, as well as are intangible costs. When scoring by cost, the late cost is considered an intangible cost. Each service point object has its own late cost, so the user can make it more difficult to be late to some service points over others. Rather than time window weight, over time weight, and over availability weight values in the model, when scoring by cost, overtime and over availability are penalized by provider pay scales.

The following provider properties apply directly to the cost model when scoring by cost: (1) wage Rate; (2) salary; (3) drive time; (4) reimbursement rate (in pay per hours of driving time); (5) overtime pay; (6) over availability pay; (7) cost factor (to be multiplied by the service point cost factor property); and (8) break pay (in the break objects in the breaks collection).

The provider's cost or pay is calculated as follows: Provider Cost=Daily salary+(wagerate*hours worked)+[(drive time reimbursement rate)*(hours spent driving)]+(overtime pay*penalty function (hours worked over the provider workday length property)+(over availability pay*hours worked outside the provider's availability)+((sum of cost factor)*(servicepoint cost factor for each of the jobs in the schedule)+sum of break pay (for all breaks taken during the shift).

There are several types of providers, including salaried, hourly, and fee per service. Usually a provider will not have a non-zero daily salary, a non-zero wage rate, and a non-zero cost factor. A provider almost always falls into one of these categories. However, even if a provider is salaried and, therefore, is not paid extra for overtime, a zero value for overtime means that the present embodiment will give them as much overtime as necessary to create a least-cost solution. Therefore, it is important to provide an intangible cost to penalize overtime sufficiently so as not to make more overtime than necessary.

Fees for service providers should also be given an overtime penalty to avoid the circumstance where they get too many jobs. One other way to limit overtime is to limit the number of jobs providers are assigned, using the provider maximum jobs property. However, use of this property may still result in unpredictable results, since service points can have different job lengths and can be separated by vastly different distances and drive times. The provider can be under-utilized or still incur overtime.

Finally, as in the case of scoring by time, the calculated score when scoring by cost also has the intangible costs of skill failures, capacity failures, and continuity of care failures added in. It is preferred to balance the preference failure weights against the other cost factors so as to not overwhelm them. Typically, preference failure weights will range from 10 to 100, but higher weights may be necessary.

When scoring by time, a homogeneous workforce is assumed and all scoring quantities are reduced to a common unit of time. Time window errors and drive times, in addition to skill failure weights, are all on the same ground. The only difference between any providers in this model is determined by the provider score weight property. In most circumstances, scoring by cost is the preferred way to use the scheduling engine of the present embodiment.

The present embodiment uses the following scoring model properties only when scoring by time: (1) time window weight; (2) late weight; (3) overtime weight; and (4) over availability weight. The following model is applied when scoring by time:

Schedule Score=Time window weight*(late weight)*

(late penalty)+[(overtime weight)* (overtime penalty)]+(over availability weight*over availability penalty)+(1−time window weight)*driving time+(sum of skill failure weight)* (number of skill failures)+(sum of continuity of care failure weights)* (continuity of care failures)+capacity failure weight*number of capacity failures.

In this model, the late penalty is the sum of the late penalty functions for each of the schedule items in the schedule. Similarly the overtime penalty is the result of the overtime penalty function, and the over availability penalty is the result of the over availability penalty function. Also, the entire score is multiplied by the score weight property of the provider object for this schedule.

Some companies desire optimum driving time, while other companies require no late or overtime. These are conflicting objectives in the real world, and often-small amounts of late time or overtime require that driving time is sacrificed. A good value for the time window weight is 0.5, and the user should slide this value slightly higher or lower to favor time window error or driving time optimization. If a value of 0.5 is used, then it is suggested to use a value of 1 for late weight and 0.5 each for overtime weight and over availability weight.

Note also that some of the intangible weights, such as skills, continuity of care, and capacity (in bin-packing problems) are judged against the time window error and driving time. These weights should not be so high that they overwhelm the other effects. It is necessary to determine how much a skill failure is worth. A hard skill failure might very well be worth 100,000 hours of time error, since such a failure might cause harm or result in death.

A preference factor, such as how much it is worth to the company to keep a smoker away from a patient that prefers a non-smoker, or to send a provider that a patient prefers, or to not send a provider that a patient does not like may have different values. The values may vary from 1 hour of late, to 3 hours of overtime. It just might require these kinds of cost overruns to meet these types of preferences. We suggest that you set the weights for required skills to be high, such as 100 or 500. Secondary skill weights should be kept smaller, for example, 10 or less, and preference weights should be kept smaller still, such as 2 to 4. The capacity failure weight for bin-packing problems should be kept high, such as 500 to 1000 to minimize this source of error.

Penalty functions are important to consider, because of the different ways you can use them to affect the solution score. The time penalty function has the (potentially non-linear) form:

Coefficient=(Amount of Hours to Penalize)ˆ Exponent.

To penalize all time equally, the exponent can be set to 0 and the coefficient to any value. A linear model is one in which the Coefficient=Exponent=1. Other functional forms include the quadratic (Exponent=2) and the radical (Exponent=½). The coefficient is multiplied by whatever the respective weight is, and, therefore, one can set a weight to one value and the coefficient to another. However, it is the product that matters to the score.

To preclude all overtime, either set the overtime weight to some high number or set the coefficient of the overtime penalty function to a high number.

Recall that each service point object has its own late penalty function, and each provider object has its own overtime and over availability penalty functions. For example, in a home-health agency aide workers might have linear functions, because it is not critical that their work be completed by a specified time. Nurses, on the other hand, who give insulin shots might have much more stringent penalty functions. Being late for a critical task might be disastrous. Also, some service providers might quit if they are asked to work overtime or outside their availability at all, while others may welcome the overtime. It is possible to customize the scoring model by setting these properties to accommodate these important preferences.

Waiting time can be a nuisance to any schedule, because it represents unproductive time and highlights a poorly designed schedule. Even though waiting time rarely costs a company money (except in cases of hourly employees), it is desirable to diminish waiting time in a schedule if at all possible.

Waiting time can come from service point time windows. In the former case, a provider arriving at a customer's site before the time window start must wait until that time. In the latter case, if two providers are dispatched to a customer's site, then the second one must wait until the first one is finished.

The “minimize waiting heuristic” algorithm can help reduce waiting time by re-arranging the arrival times of all service points in a schedule by using the width of the service point time windows in the route. This algorithm can be enabled by setting some flags in the scoring model. This may be desirable only in case of the hourly employees or in all cases. The minimize waiting bias allows room for error against the end of the service point time windows.

Another way to penalize waiting time in a schedule is to use a special algorithm to add a penalty cost for long waiting periods to the cost model. In this case, if the waiting time is longer than the time it takes for the provider to drive home and back again, then it is assumed that this is what the provider will do. This will add driving time to the score, thereby penalizing waiting time.

To get the most from the genetic algorithm certain actions may be taken. The use of the genetic algorithm in the present embodiment can be challenging, but the results are worth the extra effort. Various aspects of the genetic algorithm permit fine-tuning the solution to a scheduling problem. The genetic algorithm is governed by the option properties in the genetic algorithm options object.

To turn on the genetic algorithm in the present embodiment, set the Enabled property of genetic algorithm options to true, then set the population size of the genetic algorithm. A setting of 10 is reasonable, because the CPU requirements are not large and a population of this size is large enough to receive the benefit of the genetic operations.

When the “begin” function is called, a random population of solutions will be generated of a size equal to the genetic algorithm options operations number property. Heuristics can be added to the genetic algorithm's population. Finally, if the insertion improvement options enabled property is set to true, then the elite population member will be improved by this algorithm. Any better solutions will replace the current best solution.

The genetic algorithm part of the internal scheduling engine is designed to run in its own thread. The purpose of this design is to allow other genetic algorithm pools to be run concurrently within the engine in future releases of the present embodiment. If the general options synchronous property is set to true, then all genetic algorithm work will run in the API thread. If not, then all genetic algorithm work will run in a different thread from the API thread, and even from the present embodiment thread that operates the begin, work, and end functions.

When the “begin” function is called, the pool done flag is set to false and will not be set to true until the initial population is completed.

When the engine's “work” function is called, the main genetic algorithm worker function will be called, whereby generation after generation will be produced, with the hope that the genetic algorithm operations will bring forth better and better solutions. If the genetic algorithm options Num generations property is greater than 0, then this finite number of generations will be performed, and the engine will sit idle until further work is requested. If this property is 0, then the genetic algorithm will continue until the engine's “stop” function is called. The pool done flag is set to false until this work request is completed.

When the insertion improvement options enabled property is set to true and the genetic algorithm options number to improve after property is set to a number greater than 0, the insertion improvement heuristic will be run on the best solution in the population after the number of generations in the number to improve after property value.

Preferably, this property is set to 20 or 30, so as not to have to wait too long for the benefit of this algorithm. However, it is not advised to set this property to 1 or 2, because then too much time will be spent in this algorithm, and the power of the genetic algorithm will not be realized quickly. The insertion improvement heuristic will be run only when the best solution in the population is different from when the last one was improved and the number of generations meets the number in the supplied property.

A genetic algorithm improves its population in steps, rather than in a continual fashion. The genetic algorithm is a natural local hill climber, but it is discrete rather than continuous. Therefore, the trends of steepest descent methods will not be seen in a genetic algorithm. Rapid improvement may be noticed within the first 50 to 100 generations, and then a better solution may not be seen for 200 or 300 more generations. This can be frustrating when the user is not sure if the optimum solution has been found or not. In fact, the genetic algorithm is prone to stagnate. That is, the population runs out of new genetic material and the solutions within the population never get better. This is an area of on-going research, but there are some ways to attack this problem at the present time.

There is a property in genetic algorithm options called reseed number. When this property is greater than 0, if the genetic algorithm has stagnated, (i.e., has not produced a better solution), after this number of generations, the entire population will be removed and a new random one will replace it. The solutions in this population will perhaps be worse than the best solution seen so far, but after the genetic algorithm continues on its way through successive generations, a better solution can sometimes be found. This new population will not include the current best solution. It will overwhelm the new genetic material and it will not include the initial heuristic solutions that comprised the original population. Because the genetic algorithm is a local hill climber, the genetic algorithm can always get stuck going up nearby local hills, and the global hill may be in a region that is sufficiently far away from the existing population members. The reseeding approach is powerful, because the randomization of the search allows for other areas of the solution space to be searched.

One common mistake is to rely on an increase in the genetic algorithm options mutation rate to eliminate stagnation. Unfortunately, the current best solution is often much better than a purely random one, and the current best solution will overwhelm the new genetic material in a mutated solution. Preferably, this property is set at 5%.

An advantage to running the genetic algorithm is that the user has an entire population of solutions to choose from, rather than just one. The user can always inspect the results using the engine's Population property. A solutions collection of solution objects will be returned. As generations progress (before reseeding) the entire population gets better and better as it climbs the local hill. There may be many attractive solutions available at this time. Of course, the current best solution can always be retrieved from the engine's Solution property.

The user should realize that if the insertion improvement heuristic is enabled and set to run on a periodic basis, then other heuristic algorithms will also be run (as part of the follow-on) if they are enabled. These include the local hill climb algorithm and the maximum removal heuristic. In fact, the maximum removal heuristic is good to run in conjunction with the genetic algorithm since it tries to produce a good insert order from a good solution produced by the insertion improvement heuristic algorithm. That is, after all, the goal of the genetic algorithm: a good insert order that produces an optimal solution through the minimum insertion heuristic algorithm.

The genetic algorithm uses the fundamental building block of the minimum insertion heuristic. All genetic algorithm operations are done on the insert orders, and not on the solutions themselves. Large problems will slow the system due to the computational complexity. It is possible to speed the production of successive generations by setting the estimate best insertion properties to true in the full insertion heuristic options and maximum removal options objects. By trying to estimate the best insertion place, rather than an exact calculation that goes through a sequence of insertion, score, and removal, the estimation can speed up the genetic algorithm by a factor of 10 or more.

When no time windows or bin packing are involved, the estimate is exact by using the triangle inequality of the driving times. However, when time windows are involved an estimate is attempted using statistical techniques. The conjunction of this estimate with successive GA generations can quickly produce very good solutions. One technique may be to use the estimation for the first 100 generations, and then use exact scoring for the next 100 generations. This technique would quickly move the GA toward a good solution and then score more accurately when trying to find the final least-cost solution.

Examples of dynamic uses of the present embodiment for daily real-time operations, may be, for example, in two completely different parts of a company's scheduling operations. The first may be for use as a planning guide, using the model to plan for future operations. The present embodiment may serve as a daily (or one-shift) scheduler, and, as such, its models can be used for proper assignment and as a predictive tool for the effects of applying a certain amount of resources to a scheduling problem. It can predict the amount of late time and overtime, and how much the daily schedule will cost. However, the ability to plan for errors in a model schedule when going “live” is critical to the success of applying computer-aided dispatching algorithms to optimize a company's objectives.

Many algorithms and methods have been added to the present embodiment to support dynamic operations so that as few changes as possible are made when method and systems to respond to various kinds of messages from the field. These methods will indicate what schedules need to be changed and what measures need to be taken in response to various pieces of information. Emergency orders can come in that must be filled fast, providers may call in sick, and new providers can be called in to replace them. All of these methods are designed to handle such scenarios, and the present embodiment can operate well for these critical applications.

The genetic algorithm in the present embodiment also serves well for planning purposes, but it is less than ideal for real-time operations in dynamic daily operations. The genetic algorithm will jumble schedule assignments between the provider resources, which can cause confusion in the field if dispatchers are constantly instructing providers to go to some sites and then changing the orders. The only way this can work is in “taxi-cab” dispatching mode, where each provider receives his next job immediately after finishing the previous job. Although this method can lead to truly optimal solutions during daily operations, it requires excellent communication between the dispatcher and the providers. The examples that follow will not assume “taxi-cab” mode and are supplied with real situations in mind. These situations are assumed to be based on a scenario where The present embodiment is used in a planning mode before the shifts start, and then as the day progresses, dynamic operations are required to respond to error messages and other information from the field. The goal is to disrupt as few schedules as possible, while trying to preserve the integrity of the solution being performed in the field.

In daily operation, as opposed to planning operations, it is assumed that all service orders to be scheduled for the day are tallied. The present embodiment, in this mode, has already spent its time crunching on the data, and daily schedules are in the process of being performed by the available providers for the day.

Real-time information and message types that require dynamic response, include messages from the providers in the field, and take the following form:

Job Update: A provider indicates that an adjustment in the service time for a job must be made. Accompanying this message is a change in the service type of the job or a completion time estimate.;

Job Completed: A provider indicates that a job has just been completed. Accompanying this message are (1) time of arrival; (2) time of job completion; (3) time of break (if any) taken before working on this job; (4) time of break (if any) taken during this job; and (5) optionally drive time estimate from the previous place on the route;

Provider Leaving Early: A provider has to leave the shift early and will not complete the rest of the route;

Provider on Break: The provider is going on break for a specified amount of time;

Provider Starting Shift: The provider (usually one that has been specially called in) is starting the shift; and

Provider Route Delayed: A provider's vehicle has broken down and the route must be delayed. Accompanying this message is the expected time of being back on the job.

Messages coming in from other sources to the dispatching software take the following form:

New Emergency Order: An emergency order is received and must be completed within a time limit;

Remove Job: A service order does not need to be done anymore and must be deleted from the day's schedule;

New Provider: A new provider has been called in and needs to be assigned work; and

Remove Provider: A provider calls in sick or will not be able to work.

As each of these messages come in, the present embodiment can be used to properly handle the information that they convey. In some cases, the information will have to be translated into the correct type of information that is passed to the present embodiment via the API. On the return trip, the information coming back from the present embodiment must be translated properly into messages to be relayed to the field.

The present embodiment provides a response to real-time information and messages. The present embodiment API has algorithms that are designed to operate under the assumption that during daily operations the number of messages made in response to each message type is to be kept to a minimum. The present embodiment will work best when as much information from the field as possible can be used to produce the solutions.

The Job Update message accomplishes two essential tasks: The first is that the present embodiment is able to know which provider is about to complete a task. No other provider will ever get assigned this job, no matter how much optimization is applied. This job becomes forever locked to this provider. The second is that a job modeled in the present embodiment can be updated to reflect a better estimate of the amount of time this job will take.

The method to call in the present embodiment is job update function. The job ID and provider ID input to this method must already have been initialized into the present embodiment engine via one of the input data APIs. The job length represents a new estimate for the length of the job to be completed by this provider. Typically, the message will send to the dispatching software a new type of job that better reflects the job that the provider will do. For example, in the case of a gas utility organization, a gas turn-on straight meter is specified instead of a gas turn-on special meter. In a local database, the software will retrieve that the new type takes 45 minutes to complete, while only 20 minutes were assigned for the originally specified type. The dispatching software must call the present embodiment with this change to the new job length estimate.

The job completed message carries the job update message several steps further. The present embodiment is now able to determine that not only a specified job was handled by a certain provider, but also that the scoring model is able to lock down times for which this job was completed. The function to call in the present embodiment is job completed function. The start time is the time that this provider started the job and the end time is the time that this provider ended the job.

The present embodiment also determines if breaks were taken, both before and during the job. This will help provide a more accurate scoring model for the present embodiment regarding this work. This begins by entering the amount of time that was spent driving from the previous entity of work in the route. If this is not known, then the dispatching software should enter minus one (−1). When this function is used, during the scoring simulation in the present embodiment the arrive and end times, and the drive times and break times are anchored to the inputs. This allows the scoring function to be more accurate for part of the day, so moves made for the rest of the day can be more accurately modeled.

When a provider leaves a shift early, the jobs that were not completed by this provider must be assigned to other providers. The present embodiment function to call is remove data function with the provider or providers that are not working anymore. The scheduling engine also permits removing those jobs that they have already completed. Orphaned jobs by these providers will automatically be reassigned to other providers. The dispatching software must then check each schedule for where they were inserted. It is then necessary to notify each affected provider.

There is no direct method in the present embodiment to call when a provider notifies a dispatcher that they are going on break. However, this information can be cached in the controlling software for use with the job completed function that follows. The amount of break time indicated will be passed in as an input argument there. This will preclude the present embodiment from assigning the allotted breaks at a later time.

Calling the shuffle max item function, do shuffle heuristic function, or do migration heuristic function methods should be used when a new provider is starting a shift and the provider must be assigned work. Before calling, one of these methods, a provider object must be passed into the present embodiment using the add data function, and the starting time must be reflected in the time window start property of this provider object. The migration heuristic is perhaps the best choice, because changes to the schedules are tightly controlled in this algorithm.

If a provider route gets delayed because of unforeseen circumstances, the dispatcher will have to do manual moves of down-stream jobs that are in danger of having missed appointment times. The user could call the job update function with a large time quantity for the expected amount of the delay (from wherever the provider called from). Then the do shuffle heuristic function or shuffle max item functions could be called to re-route service points that will have large time window errors that are in the route down stream.

If an emergency service order comes in that must be scheduled, the add data function must be called, with the service point objects for the new orders having a very tight time window surrounding the time of day that the emergency order arrives. The add data function will not assign the jobs to the current best solution, so the user must call insert function to minimally insert it into the schedule. Calling set time function indicates to scheduling engine that running in dynamic operation mode is needed. This permits the minimal insertion algorithm to insert the new jobs at reasonable times for providers to be able to be dispatched properly to them.

Requirements and categories of requirements are flexible and may be created “on the fly.” One possible way to set up a problem that requires different penalties to be associated with the same requirements on different types of work is to set up soft skills as requirements for completing jobs. These skills are not absolutely required to perform the job, but any solution returned by the present embodiment to should include providers that have the appropriate skills.

In order to decouple the weighting system from the relative importance of the skill, a scaling factor should be added to the system to weight the skill against the overtime, time windows, for example. When the actual category is set up, the weights from the settings file would be used to set the penalty weight for the category.

In such an example, the provider skills would be reflected in the user interface. In order to match the provider skill with the job requirements, the skill must match. Each skill would have to be concatenated with a code indicating the level of importance, because each skill name the provider has must match a skill name in the requirements universe set.

In addition to the above described examples, numerous other examples and applications of the scheduling engine are highly feasible. In essence, one of the major strengths of the present invention relates to its fundamentally universal utility. Having thus described the scheduling engine of the present invention, however, what we claim as new and desire to secure by letters patent is set forth in the following claims.

What we claim is:

1. A scheduling engine for optimally scheduling the allocation of a set service providers to a defined set of service points, comprising:
a service point mechanism for collecting and processing a plurality of service point data parameters, said service point data parameters being not necessarily independent from one another;
a service provider mechanism for collecting and processing a plurality of service provider data parameters, said service point data parameters being not necessarily independent from one another;
a generic multi-layer scheduling mechanism for generating allocation schedules for allocating the set of service providers to the set of service points, said generic multi-layer scheduling mechanism employing a heuristic algorithm for creating an objective function relating to said plurality of service point data elements and said plurality of service provider data elements and generating therefrom said optimal allocation schedule.

2. The scheduling engine of claim 1, wherein said generic multi-layer scheduling mechanism further comprises instructions for successively proceeding through increasingly optimal allocation schedules until a final optimal allocation schedule results.

3. The scheduling engine of claim 1, wherein said generic multi-layer scheduling engine further comprises a genetic analysis mechanism for testing successive allocation schedules for verifying improvement over previously generated allocation schedules.

4. The scheduling engine of claim 3, further comprising a variable scoring model for changing said successive allocation schedules for accommodating different customer business aspects.

5. The scheduling engine of claim 4, wherein said genetic analysis mechanism requires only two solutions for comparing to improve over previously generated allocation schedules independent of the type of employed heuristic algorithm.

6. The scheduling engine of claim 1, wherein said genetic multi-layer scheduling mechanism further comprises a plurality of meta-heuristics for successively testing the optimality of a population of solutions for proceeding towards an optimal solution independent of linearity constraints.

7. A scheduling engine for processing a plurality of scheduling problems, comprising:
instructions for defining a set of inputs, control parameters, and mathematical cost models;
instructions for generating a set of initial starting conditions;
a scoring cost model evaluator for generating the state of an elite solution and guiding operations of said heuristic algorithm; and
said scoring model evaluation further for guiding the operation on the population of solutions regardless of nonlinearity or dependence among said set of inputs, control parameters, and mathematical cost models.

8. The scheduling engine of claim 7, wherein said instructions for generating said set of initial starting conditions further comprises instructions for randomly generating said set of initial starting conditions.

9. The scheduling engine of claim 7, wherein said instructions for generating said set of initial starting conditions further comprises instructions for receiving said set of initial starting conditions from an associated heuristic solution.

10. The scheduling engine of claim 7, wherein said scoring model evaluator further comprises instructions for iteratively modifying said set of inputs for converging to an optimal solution.

11. A method for scheduling engine for optimally scheduling the allocation of a set service providers to a defined set of service points, comprising the steps of:
collecting and processing a plurality of service point data parameters, said data parameters being not necessarily independent from one another;
collecting and processing a plurality of service provider data parameters, said service point data parameters being not necessarily independent from one another; and
generating allocation schedules for allocating the set of service providers to the set of service points, said generic multi-layer scheduling mechanism employing a heuristic algorithm for creating an objective function relating to said plurality of service point data elements and said plurality of service provider data elements and generating therefrom said optimal allocation schedule.

12. The method of claim 11, wherein said generic step further comprises the step of successively proceeding through increasingly optimal allocation schedules until a final optimal allocation schedule results.

13. The method of claim 11, wherein further comprising the step of testing successive allocation schedules to verify improvement over previously generated allocation schedules.

14. The method of claim 13, further comprising the step of changing said successive allocation schedules for accommodating different customer business aspects.

15. The method of claim 14, wherein said changing step requires only two solutions for comparing to improve over previously generated allocation schedules independent of the type of employed heuristic algorithm.

16. The method of claim 11, further comprising the step of successively testing the optimality of a population of solutions for proceeding towards an optimal solution independent of linearity constraints.

17. A method algorithm for processing a plurality of scheduling problems comprising the steps of:
defining a set of inputs, control parameters, and mathematical cost models;
generating a set of initial starting conditions;
generating the state of an elite solution and guiding operations of said heuristic algorithm using a scoring cost evaluator; and
guiding the operation on the population of solutions regardless of nonlinearity or departure among said set of inputs, control parameters, and mathematical cost models using a scoring cost evaluator.

18. The method of claim 17, wherein generating said set of initial starting conditions step further comprises the step of randomly generating said set of initial starting conditions.

19. The method of claim 17, wherein generating said set of initial starting conditions step further comprises the step of receiving said set of initial starting conditions from an associated heuristic solution.

20. The method of claim 17, scoring model evaluator further comprising the step of iteratively modifying said set of inputs for converging to an optimal solution.
